(19) United States
(12) Patent Application Publication
(10) Pub. No.: US 2010/0110849 A1
(43) Pub. Date: May 6, 2010

(54) INFORMATION RECORDING/REPRODUCING DEVICE AND METHOD

(75) Inventors: Takanori Maeda, Saitama (JP); Tomotaka Yabe, Saitama (JP); Hirokazu Takahashi, Saitama (JP); Masahiro Ishimori, Saitama (JP); Jun Suzuki, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/531,756

(22) PCT Filed: Mar. 19, 2007
(86) PCT No.: PCT/JP2007/055541

§ 371 Date: Dec. 28, 2009

(51) Int. Cl. G11B 7/12

(52) U.S. Cl. 369/47.49; G9B/7

(57) ABSTRACT

An information recording/reproducing device includes with a recording medium having a recording surface and a probe array in which a plurality of probes are disposed in a direction intersecting at least a track direction for carrying out either the record processing or the reproduction processing of information by scanning a plurality of information tracks in parallel with the track direction along the rack direction on the recording surface. One of the recording medium and the probe array is divided into a plurality of divided portions in the intersecting direction, so that each of them is configured to include at least one information track or probe. The information recording/reproducing device also includes a first driving element for driving each of the plural portions divided in the intersecting direction and a second driving element for driving each of the probe arrays in the track direction with respect to the recording surface.

### TECHNICAL FIELD

The present invention relates to, for example, an information recording/reproducing apparatus and method which records information onto a recording medium formed of a ferroelectric substance or the like, or which reproduces the recorded information, by using a plurality of probes arranged in an array form.

### BACKGROUND ART

As this type of information recording/reproducing apparatus, there is an apparatus which brings a plurality of cantilever-type probes into contact with a high-density, small recording medium, thereby reading and/or writing information. For example, the information is recorded or reproduced by using the plurality of probes arranged in a direction perpendicular to a scanning direction to scan a plurality of linear information tracks having a predetermined length, in parallel. In such construction, for example, if there is a temperature difference between the recording medium and the probe array in which the plurality of probes are disposed, a difference in their thermal expansion coefficients causes a deviation between the information tracks and each probe, which makes it hardly possible to read and/or write the information. Thus, there has been suggested a technology in which the recording medium or the probe array is divided into a plurality of block areas and each of the block areas is driven independently (refer to a patent document 1).
Patent document 1: Japanese Patent Publication No. 3029499

### DISCLOSURE OF INVENTION

### Subject To Be Solved By the Invention

In the aforementioned technology, however, the independent drive of each block area causes an increase in size of an actuator for drive, and this basically makes it hard to simplify and miniaturize the apparatus, which is technically problematic. In particular, in order to perform super high-density recording, it is extremely preferable to form the plurality of probes in a small area (or domain), so that the simplification or miniaturization of the apparatus here is extremely important.

In view of the aforementioned problems, it is therefore an object of the present invention to provide an information recording/reproducing apparatus and method which are suitable for the simplification of the apparatus structure.

### Means For Solving the Object

The above object of the present invention can be achieved by an information recording/reproducing apparatus provided with: a recording medium having a recording surface; and a probe array for scanning a plurality of information tracks which are arranged in parallel along a track direction, in parallel in the track direction on the recording surface, thereby performing at least one process of information recording and reproduction, the probe array having a plurality of probes arranged in a crossing direction of crossing at least the track direction, at least one of the recording medium and the probe array being divided in the crossing direction into a plurality of divided portions each of which includes at least one information track or probe, the information recording/reproducing apparatus further comprising: a first driving device capable of driving each of the plurality of divided portions in the crossing direction; and a second driving device for driving the probe array with respect to the recording surface in the track direction.

According to the information recording/reproducing apparatus of the present invention, in its recording or reproduction operation, at least one process of information recording and reproduction is performed by the plurality of probes scanning the plurality of information tracks which are arranged in parallel along the track direction, in parallel in the track direction on the recording surface of the recording medium formed of a ferroelectric substance or the like. Such displacement or scanning of the probe array in the track direction is performed by the second driving device such as an actuator for scanning the probe array or the like. Here, the expression “the probe array having a plurality of probes arranged in a crossing direction” means that the plurality of probes are arranged in the crossing direction (e.g. in a longitudinal direction or a Y-direction) and that the plurality of probes may be arranged in the track direction (e.g. in a lateral direction or an X-direction). Typically, many probes are arranged even in the track direction, so that a large amount of information can be read or written, simultaneously. However, even if there is only one probe in the track direction, the effect of the present invention due to the adjustment in the crossing direction can be exerted properly.

In particular, in the present invention, one of the recording medium and the probe array is physically divided in the crossing direction into the plurality of divided portions each of which includes at least one information track or probe. In other words, if the recording medium is divided, each of the divided portions includes at least one information track. If the probe array is divided, each of the divided portions includes at least one probe. Incidentally, the number of information tracks or probes included in each of the divided portions may be the same or different. Moreover, the expression “being divided in the crossing direction” means being divided by a dividing line extending in a direction along the information tracks. At this time, one or a plurality of dividing lines may be set.

Each of the plurality of divided portions divided in the above manner can be driven in the crossing direction by the first driving device such as an actuator for adjusting a gap of the divided portions. In other words, the gap of the divided portions can be adjusted to a desired gap by the first driving device. Thus, for example, if thermal expansion or the like causes a deviation between the information tracks and the probes and if the probes cannot scan the information tracks, each of the plurality of divided portions is driven in the crossing direction before, simultaneously with, or in tandem with the aforementioned recording and reproduction, and the deviation can be corrected in each divided portion. Therefore, even if there is the deviation between the information tracks and the probes, it is possible to correctly record or reproduce the information.

Moreover, the effect of the deviation correction described above changes depending on the number of divided portions, and division into more divided portions provides finer correction. In contrast, the smaller number of divided portions simplifies the structure of the apparatus. Thus, the number of division is determined on the basis of a difference in coefficient of thermal expansion between the recording medium and the probe array, an operating temperature range of the apparatus, a track deviation allowable range in the recording or reproduction, or the like.

As explained above, according to the information recording/reproducing apparatus in the present invention, it is possible to correctly record or reproduce the information even if there is the deviation between the recording medium and the probes, while realizing the simple structure of the apparatus.

In one aspect of the information recording/reproducing apparatus of the present invention, the second driving device collectively drives the plurality of divided portions.

According to this aspect, the plurality of divided portions are correctively driven by the second driving device in the recording or reproduction operation. As described above, the deviation between the information tracks and the probes in the crossing direction is already corrected by performing the drive by the first driving device before the recording or reproduction operation. Thus, even if the plurality of divided portions are collectively driven by the second driving device, i.e. even if the probe array covering the plurality of divided portions is operated to perform the scanning, the recording or reproduction can be performed without problems.

As explained above, by collectively driving the plurality of divided portions, for example, unnecessary an increase, complication or enlargement of an actuator for drive. Thus, it is possible to prevent complication or enlargement of the apparatus. In other words, it is possible to further simplify or miniaturize the apparatus.

In another aspect of the information recording/reproducing apparatus of the present invention, the second driving device drives the other of the recording medium and the probe array that is not divided into the plurality of divided portions.

According to this aspect, in the recording or reproduction operation, the other of the recording medium and the probe array that is not divided into the plurality of divided portions is driven by the second driving device in the track direction. In other words, if the recording surface is divided, the recording medium is driven by the first driving device and the probe array is driven by the second driving device. Moreover, if the probe array is divided, the probe array is driven by the first driving device and the recording medium is driven by the second driving device.

By separately driving the recording medium and the probe array by using the first driving device and the second driving device, for example, it is unnecessary to adjacently dispose an actuator or the like. In other words, it is possible to prevent the structure of one portion of the entire apparatus from extremely becoming complicated.

As explained above, by driving the other of the recording medium and the probe array that is not divided into the plurality of divided portions by using the second driving device, it is possible to further simplify or miniaturize the apparatus.

In another aspect of the information recording/reproducing apparatus of the present invention, the first driving device can drive the plurality of divided portions by using a width which is greater than an interval between adjacent two divided portions of the plurality of divided portions.

According to this aspect, when the gap of the plurality of divided portions is adjusted, the plurality of divided portions are driven in the crossing direction by using the width which is greater than the interval between the adjacent two divided portions of the plurality of divided portions. Incidentally, the “interval” herein shall be the width of a space between the plurality of divided portions physically divided, in a state of being not driven by the first driving device.

In the aspect, in particular, as described above, the plurality of divided portions are driven by the width which is greater than the interval between the adjacent two divided portions (hereinafter, referred to as an interval of the divided portions, as occasion demands). Thus, for example, even if there is a deviation with the width which is greater than the interval of the divided portions, the deviation can be corrected by the drive in the crossing direction. In other words, as long as the divided portions move by the width which is greater than the interval, there is little deviation that cannot be corrected. Incidentally, if the divided portions are driven by the width which is greater than the interval of the divided portions, the adjacent divided portions likely collide with each other; however, the collision can be avoided by driving the divided portions in conjunction with each other (e.g. in the same direction).

Moreover, being driven by the width which is greater than the interval of the divided portions can be restated as the small interval of the divided portions with respect to the width by which the divided portions are driven in the crossing direction. Thus, since a dead space is not consumed for the interval of the divided portions, it is possible to further miniaturize the apparatus.

As explained above, by driving the plurality of divided portions by the width which is greater than the interval of the divided portions, it is possible to miniaturize the apparatus in response to the relatively large deviation.

In another aspect of the information recording/reproducing apparatus of the present invention, the first driving device and the second driving device mutually share an elastic member and an actuator, the elastic member movably supporting the plurality of divided portions in the crossing direction and in the track direction, the actuator capable of driving the plurality of divided portions in the crossing direction and in the track direction.

According to this aspect, the plurality of divided portions are supported by the elastic member movably in the crossing direction and in the track direction, and the plurality of divided portions can be driven by the actuator in the crossing direction and in the track direction. Incidentally, the “elastic member” is typically a spring and supports the plurality of divided portions by connecting the plurality of divided portions and a frame or the like placed around the divided portions.

In the aspect, in particular, since the plurality of divided portions are supported by the elastic member, even if the position is displaced by the drive by the actuator, the divided portions are kept supported certainly. Therefore, it is possible to record or reproduce the information certainly.

The above object of the present invention can be achieved by an information recording/reproducing method using an information recording/reproducing apparatus provided with: a recording medium having a recording surface; and a probe array for scanning a plurality of information tracks which are arranged in parallel along a track direction, in parallel in the track direction on the recording surface, thereby performing at least one process of information recording and reproduction, the probe array having a plurality of probes arranged in a crossing direction of crossing at least the track direction, at least one of the recording medium and the probe array being divided in the crossing direction into a plurality of divided portions each of which includes at least one information track or probe, the information recording/reproducing method provided with: a first driving process of driving each of the plurality of divided portions in the crossing direction; and a second driving process of driving the probe array with respect to the recording surface in the track direction.

According to the information recording/reproducing method of the present invention, in the first driving process, each of the plurality of divided portions is driven in the crossing direction before, simultaneously with, or in tandem with the aforementioned recording and reproduction. In other words, if there is a deviation between the probes and the information tracks, each of the plurality of divided portions is driven in the crossing direction, and the deviation is corrected in each divided portion. Typically, in the second driving process, the probe array is driven in the track direction with respect to the recording surface after or while the deviation is corrected. In other words, the recording or reproduction is performed by the probe array scanning the recording surface. Therefore, even if there is the deviation between the information tracks and the probes, it is possible to correctly record or reproduce the information. Incidentally, as described above, if there is no deviation, the first driving process may be omitted.

As explained above, according to the information recording/reproducing method of the present invention, it is possible to correctly record or reproduce the information even if there is the deviation between the recording medium and the probes, while realizing the simple structure of the apparatus.

Incidentally, even the information recording/reproducing method of the present invention can adopt the same various aspects as those of the information recording/reproducing apparatus of the present invention described above.

The operation and other advantages of the present invention will become more apparent from the embodiments described below.

### BRIEF DESCRIPTION OF DRAWINGS

FIG. 1 is a plan view showing the structure of an information recording/reproducing apparatus in a first embodiment.

FIG. 2 is a H-H′ cross sectional view in FIG. 1.

FIG. 3 is an enlarged side view showing a probe portion.

FIG. 4 is a plan view showing the structure of an electrostatic-drive actuator.

FIG. 5 are cross sectional views showing correction of a deviation between probes and information tracks.

FIG. 6 are plan views showing the structure of an information recording/reproducing apparatus in a second embodiment.

### DESCRIPTION OF REFERENCE CODES

110 recording medium
120 information track
130 probe
140 first actuator
150 first spring
160 second actuator
170 second spring
210 first fixed part
220 second fixed part
300 probe array

### BEST MODE FOR CARRYING OUT THE INVENTION

Hereinafter, embodiments of the present invention will be described with reference to the drawings. In the embodiments below, an information recording/reproducing apparatus for recording information as a polarization direction onto a ferroelectric recording medium will be exemplified, which is one example of the information recording/reproducing apparatus of the present invention.

### First Embodiment

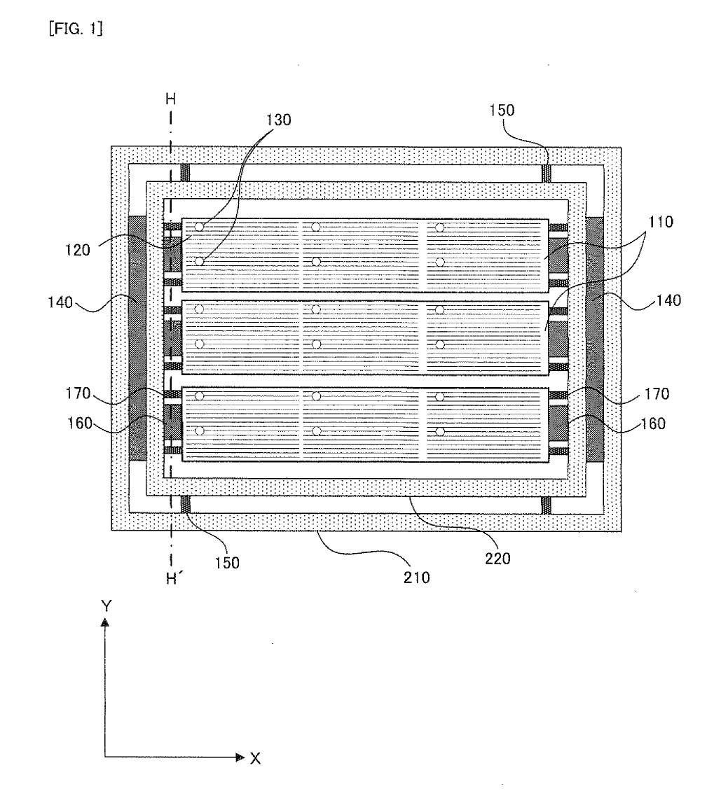

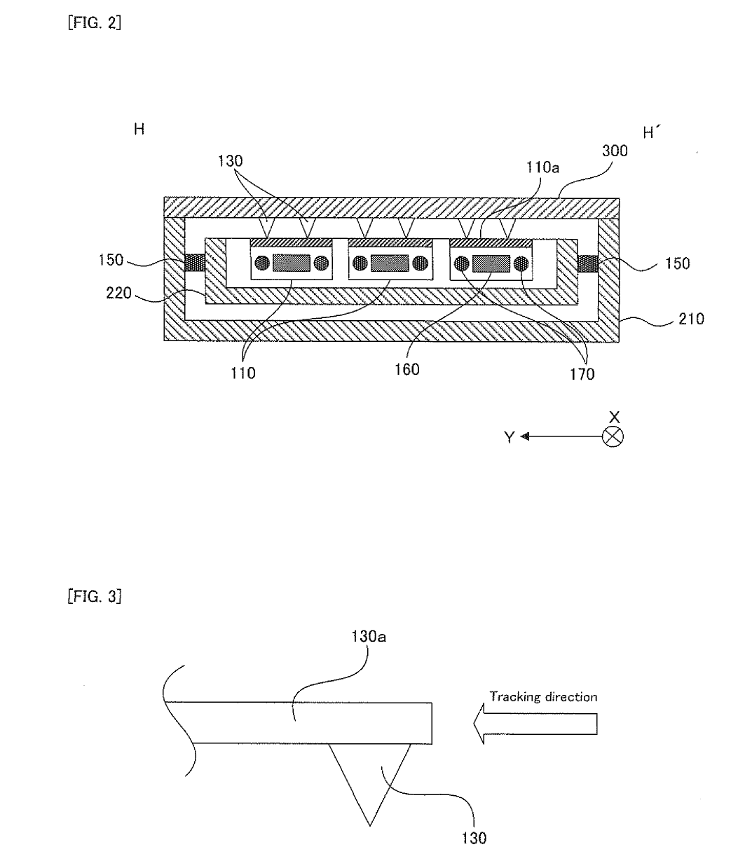

Firstly, the structure of an information recording/reproducing apparatus in the first embodiment will be described with reference to FIG. 1 to FIG. 3. FIG. 1 is a plan view showing the structure of an information recording/reproducing apparatus in the first embodiment. FIG. 2 is a H-H′ cross sectional view. FIG. 3 is an enlarged side view showing a probe portion. Incidentally, in FIG. 1, for convenience of explanation, a probe array is transparently shown.

In FIG. 1 and FIG. 2, the information recording/reproducing apparatus in the first embodiment is provided with a recording medium 110; a probe array 300 formed by arranging a plurality of probes 130; first actuators 140 and first springs 150, which are one example of the “first driving device” of the present invention; second actuators 160 and second springs 170, which are one example of the “second driving device” of the present invention; a first fixed part 210; and a second fixed part 220.

The recording medium 110 is formed by supporting a ferroelectric thin film of a PZT (lead zirconate titanate), LiTaO₃ (lithium tantalite), or the like with a plate of silicon or the like. The recording medium 110 is physically divided into three divided portions in a Y-direction shown in the drawing, and there is a space (e.g. about 0.1 mm) between the adjacent two divided portions. Information is recorded on a recording surface 110a formed of a ferroelectric thin film, as a linear information track 120 extending in an X-direction in the drawing. Moreover, on the recording surface 110a which is unrecorded, a servo mark or the like indicating an interval of the information tracks 120 may be recorded. Incidentally, here, the recording medium 110 is divided into three divided portions; however, the division may be performed such that each divided portion includes at least one information track 120, and the size of the divided portion (e.g. the number of tracks included) may be different in each divided portion.

The probe array 300 is, for example, a glass substrate, and the plurality of probes 130 are disposed on the substrate. For example, the probes 130 are disposed in a grid of 3×2 in each divided area, as shown in FIG. 1.

In FIG. 3, the probe 130 is, for example, a probe with a small tip made of silicon. The probe 130 is supported by a support part 135a, thereby being formed as a cantilever. Then, by bringing the tip into contact with the recording medium 110, the information is recorded or reproduced. Incidentally, in addition to performing the information recording or reproduction, the probe 130 can also detect the position of the information track 120 for the purpose of Y-direction control of the recording medium 110 detailed later.

The first actuators 140 and the first springs 150 support the second fixed portion 220 movably to the first fixed portion 210 and drive the recording medium 110 together with the second fixed portion 220 in the X-direction.

The second actuators 160 and the second springs 170 support the recording medium 110 movably to the second fixed portion 220 in each divided portion and can drive the recording medium 110 independently in each divided portion in the Y-direction. Moreover, the divided portions can be also driven in conjunction with, simultaneously with, or in parallel with each other.

Incidentally, the drive methods of the first actuator 140 and the second actuator 160 described above can be selected as occasion demands, in accordance with an operation speed and a drive amount, such as an electrostatic drive method using a comblike electrode, an electromagnetic method using an electromagnetic actuator, and a piezoelectric drive method using a piezoelectric effect of a ferroelectric substance. Moreover, the driving portion may be disposed in the same surface as the recording medium 110 as shown in FIG. 2, or may be disposed below the recording medium 110. Moreover, the first spring 150 and the second spring 160 are not only of a linear type shown in FIG. 2 but also of an L type or a polygonal line type so that the operation is stabilized. The aforementioned actuators are disposed to be seen from the upper surface as shown in FIG. 2; however, the placement is not limited to this, and various structures can be adopted: for example, using an electrostatic actuator with a comblike electrode sterically disposed on the back surface of the medium, an electromagnetic actuator obtained by applying a magnet onto the medium substrate, or the like.

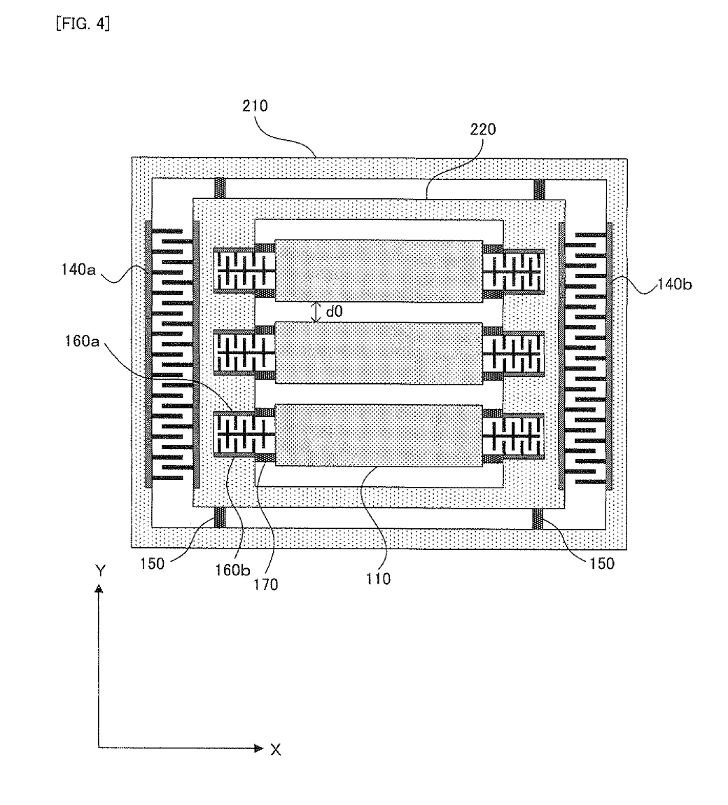

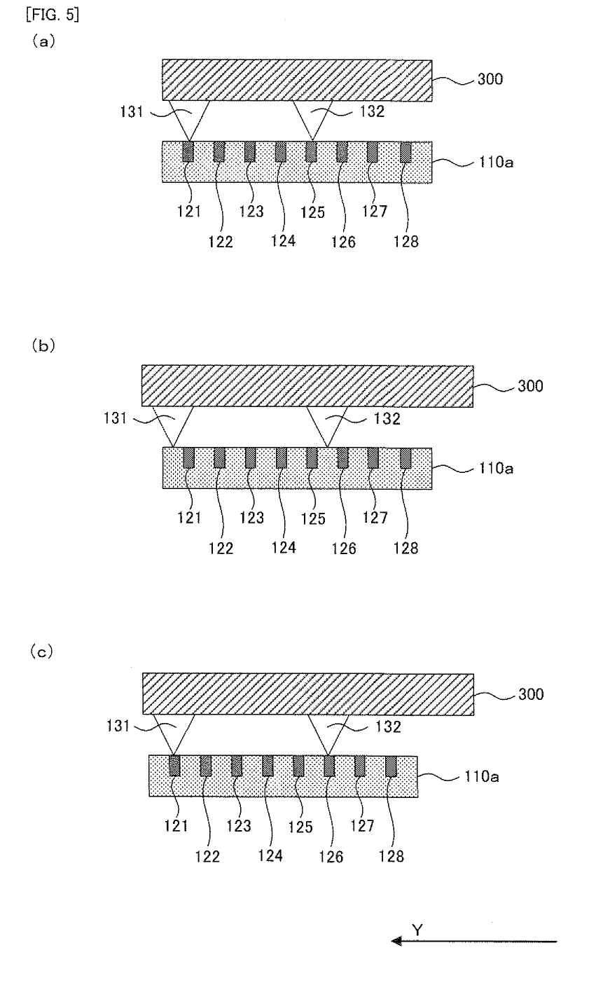

Next, with reference to the operations of the information recording/reproducing apparatus in the first embodiment will be described with reference to FIG. 4 and FIG. 5 in addition to FIG. 1 and FIG. 2. Here, an explanation will be given on the operations when the first actuator 140 and the second actuator 160 are electrostatic-drive actuators using the comblike electrode. FIG. 4 is a plan view showing the structure of the electrostatic-drive actuator. FIG. 5 are cross sectional views showing correction of a deviation between probes and information tracks. Incidentally, in FIG. 4 and FIG. 5, for convenience of explanation, the number and interval or the like of the probes, the information tracks, and the teeth of the comblike electrode are simplified.

In FIG. 4, the drive in the X-direction of the recording medium 110 is performed by the first actuators 140. For example, if a voltage is applied to a first actuator 140a on the left side of the two first actuators 140a and 140b disposed on the left and right of the recording medium 110, the opposed teeth of the first actuator 140a attract each other, thereby narrowing the interval of the teeth. By this, the recording medium 110 is displaced to the left side in the drawing, together with the fixed part 220. In the same manner, if a voltage is applied to the first actuator 140b on the right side, the recording medium 110 is displaced to the right side. At this time, the first springs 140 keeps supporting the second fixed part 220.

By the drive in the X-direction of the recording medium 110 described above, for example, the information is recorded or reproduced by the probes 130. In other words, when the recording medium 110 is driven in the X-direction, the relative position in the X-direction between the recording medium 110 and the probes 130 is changed, so that the probes 130 scan the information tracks 120 in the X-direction, and the information can be recorded or reproduced.

On the other hand, the drive in the Y-direction of the recording medium 110 is performed by the second actuators 160. The operations of the second actuators 160 are the same as those of the first actuators described above. For example, if a voltage is applied to the second actuator 160a, the recording medium 110 is displaced to the upper side, and if a voltage is applied to the second actuator 160b, the recording medium 110 is displaced to the lower side. However, the recording medium 110 is divided in the Y-direction, so that as for the drive in the Y-direction, each divided portion is independently driven by providing the second actuators 160 and the second springs 170 in each divided portion. Incidentally, the drive width (or travel distance) of the recording medium 110 may be greater than an interval d0 between the adjacent divided portions before the drive. The collision of the divided portions for the above reason can be avoided, for example, by driving the divided portions in conjunction with each other.

By the drive in the Y-direction of the recording medium 110 described above, it is possible to correct the deviation between the probes 130 and the information tracks 120 caused by a thermal expansion and an angle deviation or the like. Hereinafter, an example of the thermal expansion will be shown for specific explanation. Incidentally, in the example below, for convenience of explanation, it is assumed that only the probe array 300 is thermally expanded.

In FIG. 5(a), if there is no thermal expansion, the probes 131 and 132 are in contact with the information tracks 121 and 125, respectively. Here, if the thermal expansion occurs in the probe array 300 due to heat generated by the operations of the apparatus or the like, as shown in FIG. 5(b), the interval of the probes 131 and 132 becomes wider, and a deviation occurs between the information tracks 121 and 125. This makes it hardly possible to correctly record or reproduce the information. Here, if the aforementioned drive in the Y-direction is performed by the second actuators 160 to displace the recording medium 110 to the left side of FIG. 5, the probes 131 and 132 are brought into contact with the information tracks 121 and 126, respectively. Thus, it is possible to correctly record or reproduce the information.

As described above, since the recording medium 110 can be driven in the Y-direction, even if there is the deviation between the probes 130 and the information tracks 120, the deviation is corrected, and the information can be correctly recorded or reproduced. Moreover, without limited to the aforementioned example, if there is the deviation between the probes 130 and the information tracks 120, it is possible to take a measure by adjusting the travel distance of each divided portion. In other words, the deviation can be corrected, regardless of the cause and magnitude of the deviation or the like. Incidentally, if there is no deviation between the probes 130 and the information tracks 120, the drive in the Y-direction may be not performed. Moreover, the drive in the X-direction and the drive in the Y-direction can be also performed simultaneously.

As explained above, according to the information recording/reproducing apparatus in the embodiment, it is possible to correctly record or reproduce the information.

### Second Embodiment

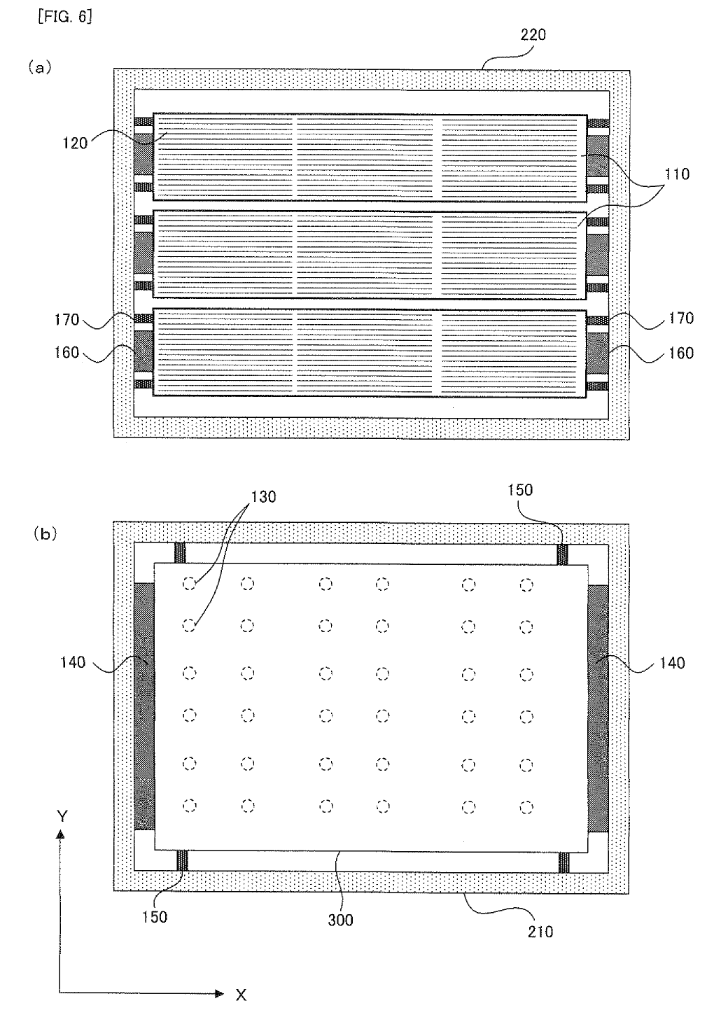

Next, an information recording/reproducing apparatus in a second embodiment will be described with reference to FIG. 6. FIG. 6 are plan views showing the structure of the information recording/reproducing apparatus in the second embodiment. Incidentally, in the second embodiment, the structure of the driving portion and its partial drive method are different in comparison to the first embodiment, and the other structures and operations are substantially the same. Thus, in the second embodiment, the different structure and operation from those of the first embodiment will be explained in details, and the explanation of the other structures and operations will be omitted as occasion demands.

In FIG. 6(a), in the information recording/reproducing apparatus in the second embodiment, the recording medium 110 is divided into three divided portions, and each divided portion is supported by the second actuators 160 and the second springs 170, movably to the second fixed portion 220.

In FIG. 6(b), the probe array 300 is supported by the first actuators 140 and the first springs 150, movably to the first fixed portion 210. Moreover, the probe array 300 is disposed on the recording medium 110 in FIG. 6(a) (i.e. on the front side of the paper).

In the information recording/reproducing apparatus in the second embodiment, the drive in the Y-direction is performed by that the recording medium 110 is driven by the second actuators 160, as in the first embodiment; however, the drive in the X-direction is performed by that the probe array 300 is driven by the first actuators 140. As described above, even if the probe array 300 is driven instead of the recording medium 110, there is no difference from the change in the relative position in the X-direction between the recording medium 110 and the probe array 300. Thus, for example, the information tracks 120 can be scanned by the probes 130, and the information can be recorded or reproduced.

As explained above, according to the information recording/reproducing apparatus in the second embodiment, the local complication of the apparatus is prevented by separately disposing the first actuators 140 and the first springs 150 which are one example of the “first driving device” of the present invention, and the second actuators 160 and the second springs 170 which are one example of the “second driving device” of the present invention, on the recording medium 110 and the probe array 300. Thus, it is possible to correctly record or reproduce the information by virtue of the simple structure of the apparatus.

Although an explanation was given on the case where the recording medium 110 is divided into the divided portions, the probe array 300 may be divided. In this case, the same effect is achieved by driving the probe array 300 in the Y-direction.

The present invention can be applied not only to an information recording/reproducing apparatus which uses the polarization of the ferroelectric substance explained in the aforementioned embodiments but also to an information recording/reproducing apparatus which uses a method of recording information as unevenness into a polymer film, a phase change method of recording information by crystallizing a phase change medium, a near-field recording method using a small optical spot, or the like.

The present invention is not limited to the aforementioned example, but various changes may be made, if desired, without departing from the essence or spirit of the invention which can be read from the claims and the entire specification. An information recording/reproducing apparatus and method, all of which involve such changes, are also intended to be within the technical scope of the present invention.

### INDUSTRIAL APPLICABILITY

The information recording/reproducing apparatus and method of the present invention can be applied to an information recording/reproducing apparatus or the like for recording information onto a recording medium formed of a ferroelectric substance or the like or reproducing the recorded information, by using a plurality of probes arranged in an array form.

1-6. (canceled)

7. An information recording/reproducing apparatus comprising:
a recording medium having a recording surface; and
a probe array for scanning a plurality of information tracks which are arranged in parallel along a track direction, in parallel in the track direction on the recording surface, thereby performing at least one process of information recording and reproduction, said probe array having a plurality of probes arranged in a crossing direction at least over the track direction,
at least one of said recording medium and said probe array being divided in the crossing direction into a plurality of divided portions each of which includes at least one information track or probe,
said information recording/reproducing apparatus further comprising:
a first driving device capable of driving each of the plurality of divided portions in the crossing direction; and
a second driving device for driving said probe array with respect to the recording surface in the track direction,
wherein said second driving device collectively drives the plurality of divided portions.

8. The information recording/reproducing apparatus according to claim 7, wherein said second driving device drives the other of said recording medium and said probe array that is not divided into the plurality of divided portions.

9. The information recording/reproducing apparatus according to claim 7, wherein said first driving device can drive the plurality of divided portions by using a width which is greater than an interval between adjacent two divided portions of the plurality of divided portions.

10. The information recording/reproducing apparatus according to claim 7, wherein said first driving device and said second driving device mutually share an elastic member and an actuator, the elastic member movably supporting the plurality of divided portions in the crossing direction and in the track direction, the actuator capable of driving the plurality of divided portions in the crossing direction and in the track direction.

11. An information recording/reproducing method using an information recording/reproducing apparatus comprising: a recording medium having a recording surface; and a probe array for scanning a plurality of information tracks which are arranged in parallel along a track direction, in parallel in the track direction on the recording surface, thereby performing at least one process of information recording and reproduction, said probe array having a plurality of probes arranged in a crossing direction at least over the track direction,
at least one of said recording medium and said probe array being divided in the crossing direction into a plurality of divided portions each of which includes at least one information track or probe,
said information recording/reproducing method comprising:
a first driving process of driving each of the plurality of divided portions in the crossing direction; and
a second driving process of driving said probe array with respect to the recording surface in the track direction,
wherein said second driving process collectively drives the plurality of divided portions.
